(19) United States
(12) Patent Application Publication
(10) Pub. No.: US 2026/0136384 A1
(43) Pub. Date: May 14, 2026

(54) METHOD FOR SIDELINK TRANSMISSION, TERMINAL DEVICE, AND NON-TRANSITORY COMPUTER-READABLE STORAGE MEDIUM

(71) Applicant: GUANGDONG OPPO MOBILE TELECOMMUNICATIONS CORP., LTD., Dongguan (CN)

(72) Inventor: Yi DING, Dongguan (CN)

(21) Appl. No.: 19/442,998

(22) Filed: Jan. 7, 2026

Related U.S. Application Data
(63) Continuation of application No. PCT/CN2023/122716, filed on Sep. 28, 2023.

(51) Int. Cl. H04W 72/56; H04W 72/40

(52) U.S. Cl. CPC H04W 72/56; H04W 72/40

(57) ABSTRACT

A method for sidelink (SL) transmission, a terminal device, and a non-transitory computer-readable storage medium are provided. The above method includes performing (810) SL transmission and/or SL reception based on priority values of multiple SL transmissions, where at least two SL transmissions among the multiple SL transmissions correspond to different subcarrier spacings (SCSs).

### CROSS-REFERENCE TO RELATED APPLICATION(S)

This application is a continuation of International Application No. PCT/CN 2023/122716, filed Sep. 28, 2023, the entire disclosure of which is hereby incorporated by reference.

### TECHNICAL FIELD

Embodiments of the present disclosure relate to the field of communication technology, and in particularly to a method for sidelink (SL) communication, a terminal device, and a non-transitory computer-readable storage medium.

### BACKGROUND

In sidelink (SL) communication, a terminal device may use multiple carriers simultaneously for data transmission, thereby increasing the transmission bandwidth and thus improving the transmission rate of data. This technology is referred to as carrier aggregation (CA).

In a CA scenario, for SL transmissions on different carriers, different SL transmissions may correspond to different subcarrier spacings (SCSs). In such a case, how the terminal device performs SL transmission and/or SL reception requires further discussion and study.

### SUMMARY

Embodiments of the present disclosure provide a method for sidelink (SL) transmission, a terminal device, and a non-transitory computer-readable storage medium. The technical solution is as follows.

In an aspect of embodiments of the present disclosure, a method for SL transmission is provided. The method is performed by a terminal device and includes performing SL transmission and/or SL reception based on priority values of multiple SL transmissions, where at least two SL transmissions among the multiple SL transmissions correspond to different subcarrier spacings (SCSs).

In an aspect of embodiments of the present disclosure, a terminal device is provided. The terminal device includes a processor and a memory storing a computer program which, when executed by the processor, causes the terminal device to perform SL transmission and/or SL reception based on priority values of multiple SL transmissions, where at least two SL transmissions among the multiple SL transmissions correspond to different SCSs.

In an aspect of embodiments of the present disclosure, a non-transitory computer-readable storage medium is provided. The storage medium stores a computer program, and the computer program is executable by a processor to implement the method for SL transmission as described above.

Other features and aspects of the disclosed features will become apparent from the following detailed description, taken in conjunction with the accompanying drawings, which illustrate, by way of example, the features in accordance with embodiments of the disclosure. The summary is not intended to limit the scope of any embodiment described herein.

### BRIEF DESCRIPTION OF THE DRAWINGS

The disclosure is best understood from the following detailed description when read in conjunction with the accompanying drawings.

FIG. 1 is a schematic diagram illustrating a network architecture provided in an embodiment of the present disclosure.

FIG. 2 is a schematic diagram illustrating two transmission modes provided in an embodiment of the present disclosure.

FIG. 3 is a schematic diagram illustrating a physical layer structure of sidelink (SL) communication provided in an embodiment of the present disclosure.

FIG. 4 is a schematic diagram illustrating a physical sidelink feedback channel (PSFCH) in a slot provided in an embodiment of the present disclosure;

FIG. 5 is a schematic diagram illustrating a carrier aggregation (CA) scenario provided in an embodiment of the present disclosure.

FIG. 6 is a schematic diagram illustrating a PSFCH in a slot provided in another embodiment of the present disclosure.

FIG. 7 is a schematic diagram illustrating SL transmission provided in an embodiment of the present disclosure;

FIG. 8 is a flow chart of a method for SL transmission provided in an embodiment of the present disclosure.

FIG. 9 is a schematic diagram illustrating SL transmission provided in another embodiment of the present disclosure.

FIG. 10 is a schematic diagram illustrating SL transmission provided in another embodiment of the present disclosure.

FIG. 11 is a schematic diagram illustrating SL transmission provided in another embodiment of the present disclosure.

FIG. 12 is a block diagram of an apparatus for SL transmission provided in an embodiment of the present disclosure.

FIG. 13 is a schematic structural diagram of a terminal device provided in an embodiment of the present disclosure.

### DETAILED DESCRIPTION

To make the objectives, technical solutions, and advantages of the present disclosure clearer, the embodiments of the present disclosure are described in further detail below in conjunction with the accompanying drawings.

The network architecture and service scenarios described in the embodiments of the present disclosure are provided to more clearly illustrate the technical solutions of the present disclosure and do not constitute a limitation on the technical solutions provided by the embodiments of the present disclosure. Those skilled in the art will understand that, with the evolution of network architecture and the emergence of new service scenarios, the technical solutions provided by the embodiments of the present disclosure are also applicable to similar technical problems.

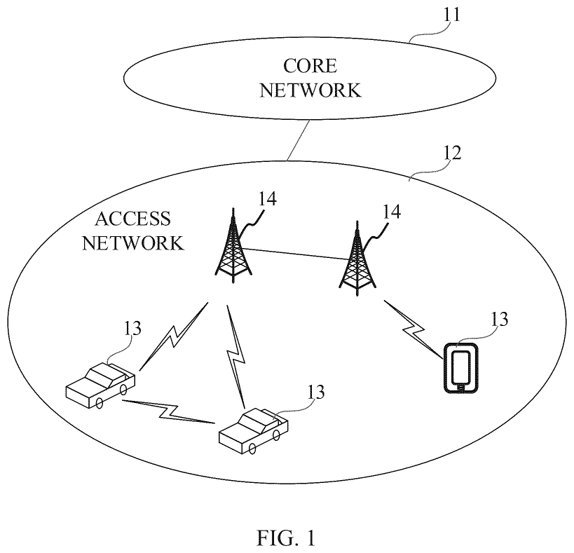

Reference is made to FIG. 1, which is a schematic diagram of a network architecture provided in an embodiment of the present disclosure. The network architecture may include: a core network 11, an access network 12, and a terminal device(s) 13.

The core network 11 includes multiple core network devices. The primary functions of the core network device are to provide user connectivity, manage users, support service bearers, and serve as an interface from a bearer network to an external network. For example, in the 5th generation (5G) new radio (NR) system, the core network may include entities such as an access and mobility management function (AMF) entity, a user plane function (UPF) entity, and a session management function (SMF) entity.

The access network 12 includes multiple access network devices 14. The access network in the 5G NR system may be referred to as next generation-radio access network (NG-RAN). The access network device 14 is a device deployed in the access network 12 to provide wireless communication functions to the terminal device 13. The access network device 14 may include various forms of macro base stations, micro base stations, relay stations, access points (APs), and the like. In systems using different radio access technologies, the name of a device with access network device functionality may vary. For instance, in the 5G NR system, it is referred to as a gNodeB or gNB. With the evolution of communication technologies, the term “access network device” may change. For the sake of illustration, in the embodiments of the present disclosure, the devices providing wireless communication functions to the terminal device 13 are collectively referred to as access network devices.

There are usually multiple terminal devices 13, and one or more terminal devices 13 may be distributed in a cell managed by each access network device 14. The terminal device 13 may include various devices having wireless communication functions such as hand-held devices, in-vehicle devices, wearable devices, computing devices, or other processing devices connected to a wireless modem, as well as various forms of user equipment (UE), mobile stations (MS), etc. For convenience of illustration, the above-mentioned devices are collectively referred to as terminal devices. The access network device 14 can communicate with the core network device through a certain air interface technology, such as an NG interface in the 5G NR system. The access network device 14 can communicate with the terminal device 13 through a certain air interface technology, such as a Uu interface. In the embodiments of the present disclosure, the term “terminal device” may also be referred to as a terminal or UE, which has the same meaning.

The terminal devices 13 can communicate with each other (for example, a vehicle-mounted device and other devices such as other vehicle-mounted devices, mobile phones, road side units (RSUs), etc.) via a direct communication interface (such as a proximity services (ProSe) communication 5(PC5) interface). Correspondingly, the communication link established based on the direct communication interface can be referred to as a direct link or sidelink (SL). SL transmission refers to direct transmission of communication data between terminal devices via an SL, which is different from traditional cellular systems where communication data is sent or received via access network devices. SL transmission features relatively low latency and relatively small overhead and is suitable for communication between two terminal devices in close geographical proximity (e.g., a vehicle-mounted device and other nearby devices within close geographical proximity). It may be noted that in FIG. 1, vehicle-to-vehicle (V2V) communication in a vehicle-to-everything (V2X) scenario is illustrated merely as an example. SL technology can be applied to scenarios in which any terminal devices can communicate directly with each other. In other words, the terminal device in the present disclosure refers to any device utilizing SL technology for communication.

The “5G NR system” in the embodiments of the present disclosure may also be referred to as the 5G system or NR system, which is understood by those skilled in the art. The technical solutions described in the embodiments of the present disclosure are applicable to the 5G NR system and may also be applicable to subsequent evolved systems of the 5G NR system.

Before describing the technical solutions of the present disclosure, some related technical knowledge involved in the present disclosure is first introduced. The following related technologies as optional technical solutions may be combined with the technical solutions of the embodiments of the present disclosure in any manner, and all of them fall within the protection scope of the embodiments of the present disclosure. The embodiments of the present disclosure include at least part of the following content.

### 1. SL Transmission

Device-to-device (D2D) communication is an SL transmission technology, which is different from traditional cellular systems where communication data is received or transmitted through a base station. For example, D2D direct communication is also adopted in V2X systems, thereby providing relatively high spectrum efficiency and relatively low transmission latency. Regarding D2D communication, the 3rd generation partnership project (3GPP) defines two transmission modes: Mode A and Mode B.

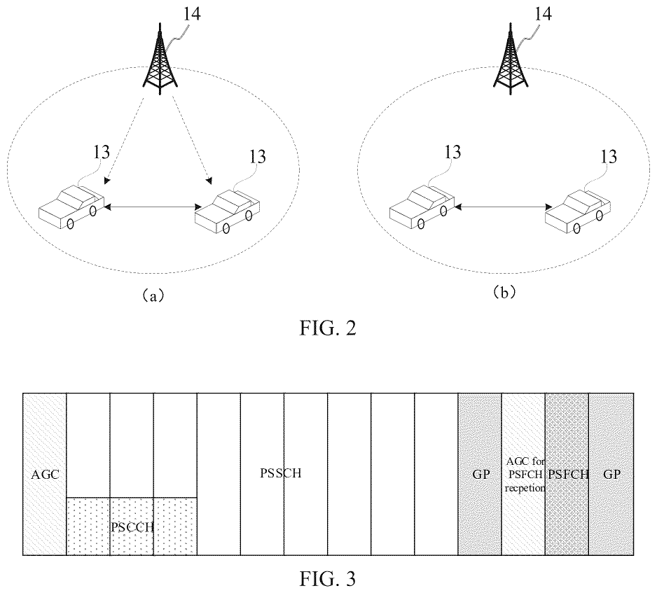

Mode A: As illustrated in sub-figure (a) of FIG. 2, a transmission resource(s) for the terminal device 13 is allocated by the access network device 14 (e.g., a base station). The terminal device 13 transmits communication data on an SL based on the transmission resource(s) allocated by the access network device 14. The access network device 14 may allocate a transmission resource(s) for a single transmission to the terminal device 13, or may allocate a a resource(s) for semi-static transmission to the terminal device 13.

Mode B: As illustrated in sub-figure (b) of FIG. 2, the terminal device 13 autonomously selects a transmission resource(s) in a resource pool to transmit communication data. Specifically, the terminal device 13 may select a transmission resource(s) from the resource pool through sensing, or may randomly select a transmission resource(s) from the resource pool.

It may be noted that, in FIG. 2, V2V communication is merely taken as an example, and SL technology may be applied to scenarios in which various terminal devices directly communicate with each other. In other words, the terminal device in the embodiments of the present disclosure refers to any type of terminal device that can perform communication using SL technology.

### 2. NR SL Physical Layer Structure

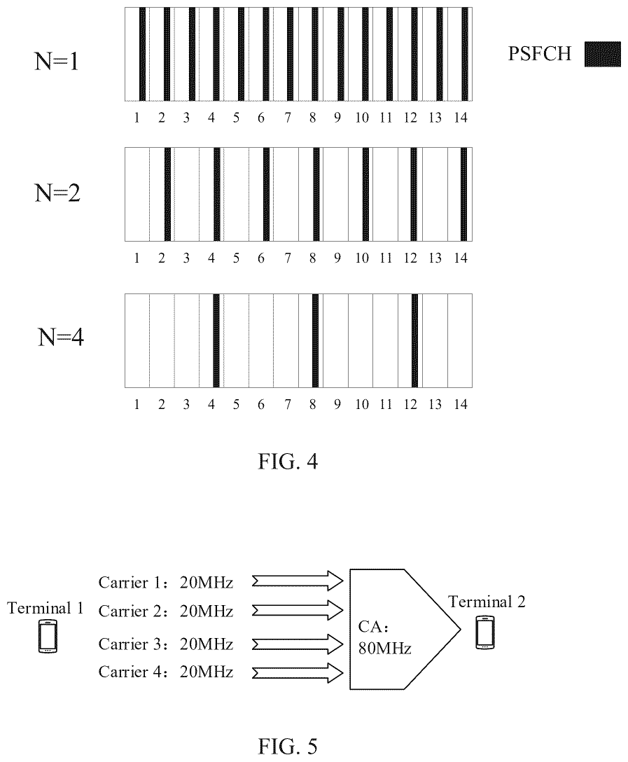

For example, FIG. 3 is a schematic diagram illustrating a physical layer structure of an NR SL system. In FIG. 3, a first symbol of a slot is an automatic gain control (AGC) symbol. When an SL UE performs reception, the SL UE may adjust a received power in this symbol to a power suitable for demodulation. When the SL UE performs transmission, the SL UE repeatedly transmits, in the AGC symbol, content in a symbol following the AGC symbol. In FIG. 3, a physical sidelink control channel (PSCCH) is used to carry first SL control information, where the first SL control information mainly includes a field(s) related to resource sensing. A physical sidelink shared channel (PSSCH) is used to carry data and second SL control information, where the second SL control information mainly includes a field(s) related to data demodulation. In a slot, a physical sidelink feedback channel (PSFCH) symbol may also exist. A PSFCH is used to transmit hybrid automatic repeat request (HARQ) feedback information. Depending on resource pool configuration, a PSFCH symbol may appear once every 1, 2, or 4 slots. When a slot does not include a PSFCH symbol, for example, as illustrated in FIG. 3, a guard period (GAP) symbol between PSSCH and PSFCH symbols, the AGC for PSFCH reception, and a PSFCH symbol are used to carry a PSSCH. Under normal circumstances, a last symbol in a slot is referred to as a GP symbol (or is referred to as a GAP symbol). In other words, a symbol following a last symbol that carries a PSSCH or a PSFCH is referred to as a GP symbol. The SL UE performs transmit-receive switching in the GP symbol and does not perform transmission in the GP symbol. When a PSFCH resource(s) exists in a slot, a GP symbol also exists between PSSCH and PSFCH symbols. This is because the UE may perform PSSCH transmission and perform PSFCH reception, and thus the GP symbol is also required for transmit-receive switching.

### 3. HARQ Feedback and PSFCH Resource

HARQ retransmission: For transmission at a transmitting end, a receiving end may feed back acknowledgement (ACK) or negative acknowledgement (NACK) or feed back only NACK (NACK-only) to the transmitting end according to whether reception is successful. ACK indicates successful reception, and NACK indicates reception failure. The receiving end performs HARQ feedback to the transmitting end through a PSFCH, namely a sidelink feedback channel.

In some embodiments, when transmission is unicast (one sender and one receiver), the receiving end feeds back ACK when reception is successful, and feeds back NACK when reception fails. Correspondingly, the transmitting end performs retransmission when detecting NACK or when failing to detect HARQ feedback information.

When transmission is multicast (one sender and multiple receivers), the following two modes are included.

1. The receiving end feeds back ACK when reception is successful and feeds back NACK when reception fails. The transmitting end performs retransmission when detecting NACK or when failing to detect HARQ feedback information. Exemplarily, the transmitting end performs retransmission when detecting at least one NACK. Exemplarily, the transmitting end performs retransmission when failing to detect HARQ feedback information corresponding to at least one receiving end.

2. The receiving end feeds back NACK only when reception fails, and performs no feedback when reception is successful. The transmitting end performs retransmission when detecting NACK. Exemplarily, the transmitting end performs retransmission when detecting at least one NACK.

PSFCH resources are configured for each resource pool. In NR-V2X, for PSFCH resource configuration, there are three configurations, i.e., N=1, N=2, and N=4. As illustrated in FIG. 4, N=1 indicates that a PSFCH resource is configured in each slot in a resource pool, N=2 indicates that a PSFCH resource is configured every two slots in a resource pool, and N=4 indicates that a PSFCH resource is configured every four slots in a resource pool. More specifically, in a slot, a PSFCH resource is configured in a second-to-last symbol among orthogonal frequency division multiplexing (OFDM) symbols available for SL transmission in the slot. It may be noted that, in the frequency domain, the example in FIG. 4 illustrates that PSFCH resources are configured over the entire frequency domain. Optionally, only a portion of physical resource blocks (PRBs) may be configured as PSFCH resources. When UE 1 transmits data (PSSCH) to UE 2 in slot t, HARQ feedback from UE 2 to UE 1 for the data transmission occurs in slot t+a. Here, a is greater than or equal to k, and in slot t+a a PSFCH resource is included. In NR-V2X, k takes a value of 2 or 3 slots. For example, in FIG. 4, assuming N=4 and k=2, if UE 1 transmits data to UE 2 in slot 1, t+a is slot 4, and UE 2 performs HARQ feedback to UE 1 in slot 4. If UE 1 transmits data to UE 2 in slot 3, t+a is slot 8, and UE 2 performs HARQ feedback to UE 1 in slot 8. Therefore, a time-domain position of a PSFCH resource for performing feedback is determined according to a time-domain position of a corresponding PSSCH for data transmission. A frequency-domain position and a code-domain resource of a PSFCH resource for feeding back HARQ information, for example, a code-domain sequence corresponding to a particular PRB, are determined according to a subchannel of a corresponding PSSCH, a source identity, and the like.

### 4. SL Carrier Aggregation (CA)

CA refers to a technique in which a communication device aggregates multiple carriers together and uses multiple carriers simultaneously for data transmission, thereby increasing the transmission bandwidth and improving the data transmission rate. In the related art, an SL CA based on long term evolution (LTE) has already been supported. In NR SL, vendors are also considering supporting SL CA. On one hand, it is to support scenarios requiring high transmission rates, such as advanced driving and extended sensor. On the other hand, it is to utilize fragmented spectrum resources and improve spectrum utilization. As illustrated in FIG. 5, FIG. 5 illustrates an example of transmission between terminals through CA, where terminal 1 performs CA on four carriers each having a bandwidth of 20 MHz, that is, terminal 1 transmits data to terminal 2 through a bandwidth of 80 MHz. Carriers subjected to CA may be located within the same frequency band or in different frequency bands, that is, there may be intra-band CA and inter-band CA. For example, carriers 1 to 4 in FIG. 5 may belong to the same frequency band or may be located in different frequency bands. Meanwhile, a subcarrier spacing (SCS) of each carrier may be the same or may be different.

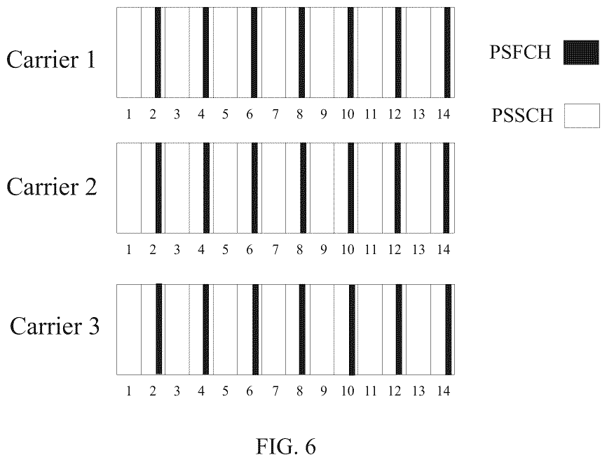

In the SL CA of the related art, the main study scenario is as illustrated in FIG. 6. It is assumed that, terminal 1 transmits data to terminal 2 on carriers 1-3 through CA, where an SCS of each carrier is the same, and PSFCH resources are aligned in the time domain.

Therefore, in the SL CA of the related art, a transmit/transmit (TX/TX) conflict and/or transmit/receive (TX/RX) conflict only exist between PSSCHs, and a TX/TX conflict and/or TX/RX conflict only exist between PSFCHs. This is mainly because the PSSCH and PSFCH on each carrier are time division multiplexing (TDM). The TX/TX conflict refers to a case where the terminal device needs to perform M transmissions simultaneously, but the capability of the terminal device can support only N transmissions, and M is greater than N. Therefore, the terminal device needs to drop some of the M transmissions to meet the capability of the terminal device. Alternatively, the terminal device needs to perform M transmissions simultaneously, but the transmit power of the M transmissions exceeds the maximum transmit power of the terminal device, and therefore, the terminal device also needs to drop some of the M transmissions so that the total transmit power is less than or equal to the maximum transmit power. The TX/RX conflict refers to a case where the terminal device needs to perform transmission and reception simultaneously, but due to half-duplex constraints, the terminal device can only drop transmission or drop reception. In resolving the above TX/TX conflict or TX/RX conflict, the determination is usually performed based on priorities for transmissions, and reference can be made to the following specific examples.

Example 1: Assume that the terminal device needs to transmit PSSCHs simultaneously in the same slot of carriers 1-M, with one PSSCH to be transmitted on each carrier, and the transmit power of the M PSSCHs is greater than the maximum transmit power Pcmax of the terminal. The terminal device first adjusts the transmit power of a PSSCH having the highest priority value (that is, the lowest priority). If, after the adjustment, the transmit power of the M PSSCHs is still greater than the maximum transmit power Pcmax, the terminal device drops the transmission of the PSSCH having the highest priority value, and if, after the adjustment, the transmit power of the M PSSCHs is not greater than the maximum transmit power Pcmax, the terminal device transmits the M PSSCHs. If, after the terminal device drops the transmission, the transmit power of the remaining M-1 PSSCHs is less than or equal to Pcmax, the terminal device transmits the M-1 PSSCHs. Otherwise, the above process is repeated to further adjust the transmit power of a PSSCH having the highest priority value or dropping transmission of the PSSCH having the highest priority value. When multiple PSSCHs have the same priority value, which of the multiple PSSCHs is selected for power adjustment or transmission dropping depending on the implementation of the terminal device.

Example 2: Assume that the terminal device needs to transmit M PSFCHs simultaneously on carriers 1-K, where M is greater than or equal to K, that is, at least one PSFCH is transmitted on each carrier. The maximum number of PSFCHs that the terminal device can transmit simultaneously equals N, and the maximum transmit power of the terminal device is Pcmax.

In the case where M is less than or equal to N, that is, the transmission capability of the terminal device is not exceeded, i.e., the transmit power of the M PSFCHs does not exceed Pcmax, the M PSFCHs are transmitted; otherwise, L PSFCHs are selected from the M PSFCHs in ascending order of priority values and are transmitted, where L is the maximum number such that the total transmit power of the selected PSFCHs does not exceed Pcmax.

In the case where M is greater than N, that is, the transmission capability of the terminal device is exceeded, N PSFCHs are selected from the M PSFCHs in ascending order of priority values. If the transmit power of the N PSFCHs does not exceed Pcmax, the N PSFCHs are transmitted; Otherwise, L PSFCHs are selected from the N PSFCHs in ascending order of priority values and are transmitted, where L is the maximum number such that the total transmit power does not exceed Pcmax.

Example 3: The terminal device needs to simultaneously transmit M PSFCHs and simultaneously receive P PSFCHs on carriers 1-K. The terminal device determines whether to transmit the M PSFCHs or receive the P PSFCHs based on a PSFCH having the lowest priority value among the M PSFCHs and P PSFCHs. For example, if the PSFCH having the lowest priority value belongs to the M PSFCHs, the terminal device performs transmission and transmits the M PSFCHs. For another example, if the PSFCH having the lowest priority value belongs to the P PSFCHs, the terminal device performs reception and receives the P PSFCHs. A priority value of a PSFCH refers to a priority value of a PSSCH associated with the PSFCH.

From the above illustration, it can be seen that in the current SL CA, an SCS of each carrier is the same, and PSFCH resources are aligned. Therefore, a TX/TX conflict and/or a TX/RX conflict only occur between PSSCHs, and a TX/TX conflict and/or a TX/RX conflict only occur between PSFCHs. However, in future CA, if an SCS of each carrier is different, a TX/TX conflict and/or a TX/RX conflict may occur between channels such as a PSSCH, a PSFCH, and a synchronization signal (SS)/physical broadcast channel (PBCH) block (SSB). How to resolve TX/TX and TX/RX prioritization in such cases still requires further study.

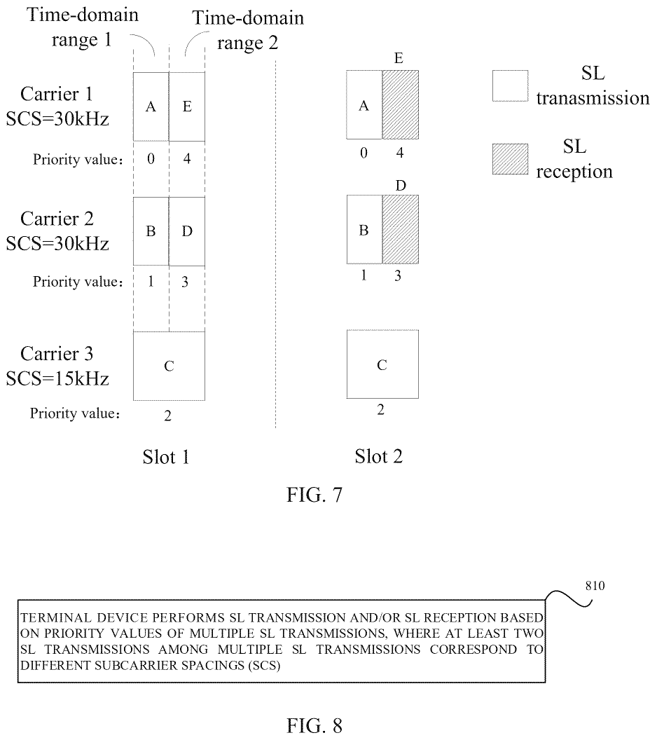

Meanwhile, when SCSs are different, multiple SL transmission groups for which TX/TX and/or TX/RX prioritization need to be determined may share the same SL transmission(s). If the determination order among different transmission groups is different, the ultimately performed SL transmissions may differ. For example, as illustrated in FIG. 7, the terminal device performs transmissions on carriers 1-3 through CA, where an SCS of carrier 3 is 15 kHz, and SCSs of carriers 1 and 2 are both 30 kHz. Therefore, a slot of carrier 3 corresponds to 2 slots of carries 1 and 2 slots of carrier 2. For SL transmissions A-E in slot 1 of carrier 3, SL transmissions A-C form transmission group 1, and SL transmissions C-E form transmission group 2. TX/TX prioritization needs to be performed for transmission group 1, and also for transmission group 2. Assuming that the maximum number of simultaneous transmissions for the terminal device is 2, if determination for transmission group 1 is performed first, SL transmission C is dropped. Then, determination for transmission group 2 is performed, and no transmission needs to be dropped. Ultimately, SL transmissions A, B, E, D are transmitted. Conversely, if the determination for transmission group 2 is performed first, SL transmission E is dropped. Then, determination for transmission group 1 is performed, and SL transmission C is dropped. Ultimately, SL transmissions A, B, D are transmitted.

Similarly, for slot 2, TX/TX prioritization needs to be performed for transmission group 1, and TX/RX prioritization needs to be performed for transmission group 2. If determination for transmission group 1 is performed first, SL transmission C is dropped. Then, determination for transmission group 2 is performed, and the terminal device performs reception for SL transmissions D and E, and ultimately performs transmission for SL transmissions A and B while performing reception for SL transmissions D and E. Conversely, if determination for transmission group 2 is performed first, the terminal drops reception of SL transmissions D and E. Then, the terminal device performs determination for transmission group 1, and drops SL transmission C. Ultimately, only SL transmissions A and B are transmitted.

The TX/TX prioritization mentioned above may be interpreted as TX/TX priority determination or TX/TX priority transmission determination. In the embodiments of the present disclosure, TX/TX priority determination is taken as an example for illustration. Similarly, TX/RX prioritization may be interpreted as TX/RX priority determination or TX/RX priority transmission determination. In the embodiments of the present disclosure, TX/RX priority determination is taken as an example for illustration.

Therefore, a rule needs to be established to standardize the determination order between transmission groups.

The embodiments of the present disclosure provide a method for SL transmission. In the case where at least two SL transmissions among multiple SL transmissions correspond to different SCSs, the terminal device performs SL transmission and/or SL reception based on priorities of the multiple SL transmissions. This solves the problem of a TX/TX conflict and/or a TX/RX conflict among SL transmissions in the case where some SL transmissions among multiple SL transmissions correspond to different SCSs.

Referring to FIG. 8, a flow chart of a method for SL transmission provided by an embodiment of the present disclosure is illustrated. The method can be applied to the network architecture as illustrated in FIG. 1. The method is executed by a terminal device and includes step 810 as follows.

Step 810, the terminal device performs SL transmission and/or SL reception based on priority values of multiple SL transmissions, where at least two SL transmissions among the multiple SL transmissions correspond to different SCSs.

A priority value of an SL transmission indicates a priority of the SL transmission.

In some embodiments, for an SL transmission, a larger priority value indicates a lower priority, and a smaller priority value indicates a higher priority. For example, if a priority value of SL transmission A is 1, and a priority value of SL transmission B is 2, it indicates that SL transmission A has a higher priority than SL transmission B.

In some embodiments, for an SL transmission, a larger priority value indicates a higher priority, and a smaller priority value indicates a lower priority. For example, if a priority value of SL transmission A is 1, and a priority value of SL transmission B is 2, it indicates that SL transmission B has a higher priority than SL transmission A.

It is noted that, in the embodiments of the present disclosure, the case that for an SL transmission a larger priority value indicates a lower priority is taken as an example for illustrative purposes

In some embodiments, the terminal device determines an SL transmission(s) that the terminal device needs to be performed based on the priority values of the multiple SL transmissions.

In some embodiments, at least two SL transmissions among the multiple SL transmissions may correspond to a same SCS.

In some embodiments, the multiple SL transmissions are located on at least two carriers.

In some embodiments, at least two SL transmissions among the multiple SL transmissions may be located on a same carrier.

For example, as illustrated in FIG. 7, SL transmissions A-E are located on three carriers, where at least two SL transmissions correspond to different SCSs. For instance, SCSs of carriers where SL transmissions A and C are respectively located are different, with the SCS of the carrier where SL transmission A is located being 30 kHz and the SCS of the carrier where SL transmission C is located being 15 kHz. SL transmissions A and E are located on a same carrier, SL transmissions B and D are located on a same carrier, and an SCS of the carrier where SL transmission A is located and an SCS of the carrier where SL transmission B is located are both 30 kHz.

Each SL transmission group is formed by at least two SL transmissions that overlap in a time domain, where each SL transmission group may also be referred to as an SL transmission set or other names. In the embodiments of the present disclosure, the term “SL transmission group” is used for simplicity.

In some embodiments, the multiple SL transmissions are divided into multiple SL transmission groups, where each SL transmission group includes at least two SL transmissions among the multiple SL transmissions, and respective SL transmissions in each SL transmission group overlap in the time domain. For example, as illustrated in FIG. 7, SL transmissions A-E in slot 1 can be divided into two SL transmission groups, where SL transmission A-C form SL transmission group 1 and SL transmissions C-E form SL transmission group 2. Respective SL transmissions in SL transmission group 1 occupy time-domain range 1, and respective SL transmissions in SL transmission group 2 occupy time-domain range 2. Respective SL transmissions in SL transmission group 1 overlap within time-domain range 1, and respective SL transmissions in SL transmission group 2 overlap within time-domain range 2.

In some embodiments, multiple SL transmission groups share at least one same SL transmission. For example, as illustrated in FIG. 7, SL transmissions A-E in slot 1 can be divided into two SL transmission groups, where SL transmissions A-C form SL transmission group 1 and SL transmissions C-E form SL transmission group 2, and SL transmission C is included in both SL transmission group 1 and SL transmission group 2.

In some embodiments, an SCS corresponding to an SL transmission refers to: an SCS of a carrier where the SL transmission is located; or an SCS of an SL bandwidth part (BWP) where the SL transmission is located; or an SCS of the SL BWP of the carrier where the SL transmission is located.

In some embodiments, in the case where an SCS corresponding to an SL transmission refers to an SCS of an SL BWP where the SL transmission is located, the SCS corresponding to the SL transmission may be an SCS in a configuration of the SL BWP where the SL transmission is located.

In some embodiments, if an SCS corresponding to an SL transmission is an SCS of an SL BWP of a carrier where the SL transmission is located, the SCS corresponding to the SL transmission may refer to an SCS in a configuration of the SL BWP of the carrier where the SL transmission is located.

In some embodiments, each SL transmission is used to transmit any one of thefollowing channels or signals: a PSCCH, a PSSCH, a PSCCH and a PSSCH, a PSFCH, or an S-SSB.

In some embodiments, for each SL transmission, the SL transmission is used to transmit any one of the following channels or signals: a PSCCH, a PSSCH, and a PSCCH and a PSSCH; a priority value of the SL transmission is a priority value of data carried in the PSSCH, or a priority value indicated by SL control information in the PSCCH.

In some embodiments, for each SL transmission, the SL transmission is used to transmit a PSFCH; a priority value of the SL transmission is a priority value of a PSSCH corresponding to the PSFCH.

For example, UE1 transmits data in a PSSCH to UE2, and UE2 transmits HARQ feedback information for the data in the PSSCH to UE1 over a PSFCH. In this case, a priority value of PSFCH transmission by UE2 refers to a priority value of the data in the PSSCH, and a priority value of PSFCH reception by UE1 refers to the priority value of the data in the PSSCH.

For example, UE1 transmits data in a PSSCH to UE2, and UE2 transmits HARQ feedback information for the data in the PSSCH to UE1 over a PSFCH. In this case, a priority value of PSFCH transmission by UE2 refers to a priority value indicated by SL control information in a PSCCH corresponding to the PSSCH, and a priority value of PSFCH reception by UE1 refers to the priority value indicated by the SL control information in the PSCCH corresponding to the PSSCH.

In some embodiments, each SL transmission is used to transmit an S-SSB; a priority value of each SL transmission is configured, preconfigured, or predefined in a standard.

In some embodiments, SL transmissions included in each SL transmission group may be SL transmissions for transmission, SL transmissions for reception, or may include an SL transmission(s) for transmission and an SL transmission(s) for reception, which is not limited in the present disclosure.

In some embodiments, each SL transmission group includes a first type of conflict and/or a second type of conflict, where the first type of conflict refers to a conflict between SL transmissions for transmission, and the second type of conflict refers to a conflict between an SL transmission(s) for transmission and an SL transmission(s) for reception.

For example, as illustrated in FIG. 7, in slot 1, SL transmissions A-E are divided into two SL transmission groups, where SL transmissions A-C form SL transmission group 1 and SL transmissions C-E form SL transmission group 2. Because the transmission capability of the terminal device allows the terminal device to transmit at most two SL transmissions simultaneously, a TX/TX conflict exists in both SL transmission groups 1 and 2, and SL transmission groups 1 and 2 share same SL transmission C. As illustrated in FIG. 7, in slot 2, SL transmissions A-E are divided into two SL transmission groups, where SL transmissions A-C form SL transmission group 1 and SL transmissions C-E form SL transmission group 2. Because the transmission capability of the terminal device allows the terminal device to transmit at most two SL transmissions simultaneously, a TX/TX conflict exist in SL transmission group 1. Since the terminal device supports half-duplex data transmission, a TX/RX conflict exists in SL transmission group 2. SL transmission groups 1 and 2 share same SL transmission C. The TX/TX conflict is referred to as the first type of conflict, and the TX/RX conflict is referred to as the second type of conflict.

In some embodiments, in the case where the first type of conflict and the second type of conflict both exist in an SL transmission group, an order of resolving the first type of conflict and the second type of conflict depends on the implementation of the terminal device.

For example, the terminal device may select to resolve the first type of conflict first based on its implementation. For example, the terminal device may select to resolve the second type of conflict first based on its implementation.

In the technical solution provided by the embodiments of the present disclosure, the terminal device performs SL transmission and/or SL reception based on the priority values of the multiple SL transmissions in a case where some SL transmissions among the multiple SL transmissions correspond to different SCSs. This solves TX/TX and/or TX/RX conflicts among SL transmissions in the case where some SL transmissions among the multiple SL transmissions correspond to different SCSs, thereby improving the reliability of SL transmissions, particularly the reliability of high-priority SL transmissions.

The present disclosure provides several exemplary embodiments regarding how the terminal device determines SL transmission and/or SL reception to be performed based on the priority values of the multiple SL transmissions.

1. The terminal device performs SL transmission and/or SL reception based on lowest priority values corresponding to the multiple SL transmission groups.

In some embodiments, the terminal device performs SL transmission and/or SL reception in ascending order of lowest priority values corresponding to the multiple SL transmissions.

In some embodiments, the terminal device determines the lowest priority value corresponding to each SL transmission group as the priority value of each SL transmission group, and performs SL transmission and/or SL reception in ascending order of the priority values of the SL transmission groups.

In some embodiments, in the case where two SL transmission groups have the same priority value, the priority order between the two SL transmission groups is determined by the implementation of the terminal device. For example, in the case where the lowest priority values corresponding to two SL transmission groups are both 2, the terminal device determines the priority order between the two SL transmission groups according to the implementation of the terminal device.

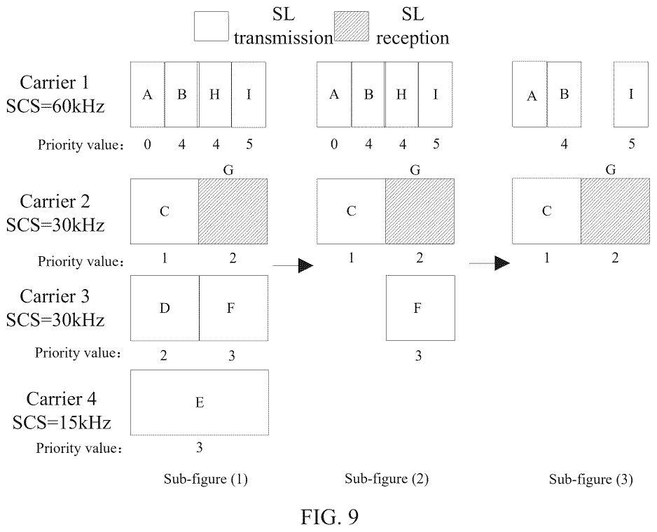

Exemplarily, as illustrated in FIG. 9, SCSs of carriers 1-4 are 60, 30, 30, and 15 kHz, respectively. Therefore, a slot of carrier 4 corresponds to 2 slots of carrier 2 and 2 slots of carrier 3, and corresponds to 4 slots of carrier 1. In sub-figure 1 of FIG. 9, SL transmissions A-I can be divided into four SL transmission groups. Specifically, SL transmissions A, C, D, and E form SL transmission group 1, SL transmissions B, C, D, and E form SL transmission group 2, SL transmissions H, G, F, and E form SL transmission group 3, and SL transmissions I, G, F, and E form SL transmission group 4. Assuming that the transmission capability of the terminal device allows the terminal device to support simultaneous transmission of at most two SL transmissions, a TX/TX conflict (the first type of conflict) exists in both SL transmission groups 1 and 2, requiring the terminal device to perform TX/TX prioritization. Due to the half-duplex constraints, both a TX/TX conflict (the first type of conflict) and a TX/RX conflict (the second type of conflict) exist in SL transmission group 3 and both a TX/TX conflict (the first type of conflict) and a TX/RX conflict (the second type of conflict) exist in SL transmission group 4, requiring the terminal device to perform both TX/TX and TX/RX prioritization. The order between TX/TX prioritization and TX/RX prioritization for a single SL transmission group depends on the implementation of the terminal device. In the exemplary embodiment, for example, TX/TX prioritization is performed first, followed by TX/RX prioritization, for illustrative purposes.

As illustrated in sub-figure (1) of FIG. 9, the lowest priority values corresponding to SL transmission groups 1-4 are 0, 1, 2, and 2, respectively. Accordingly, the terminal device first performs TX/TX prioritization for SL transmission group 1, resulting in SL transmissions D and E being dropped, as illustrated in sub-figure (2) of FIG. 9.

In sub-figure (2) of FIG. 9, for SL transmissions A, B, and C, SL transmissions A and C need to be simultaneously transmitted in SL transmission group 1, and SL transmissions B and C need to be simultaneously transmitted in SL transmission group 2, both of which do not exceed the maximum transmission capability of the terminal device; thus, SL transmissions A, B, and C can be transmitted directly. For SL transmissions H, I, G, and F, SL transmission group 3 still includes SL transmissions H, G, and F, and SL transmission group 4 still includes SL transmissions I, G, and F. In this case, SL transmission groups 3 and 4 share the same SL transmissions G and F, and both include a TX/RX conflict (the second type of conflict). Therefore, SL transmission and/or SL reception still need to be performed in ascending order of lowest priority values corresponding to SL transmission groups. As illustrated in sub-figure 2 of FIG. 9, the lowest priority values corresponding to SL transmission groups 3 and 4 are both 2. In this case, the priority order between SL transmission groups 3 and 4 can be determined depending on the implementation of the terminal device. For example, the terminal device first performs TX/RX prioritization for SL transmission group 3, dropping SL transmissions H and F and performing SL transmission G, as illustrated in sub-figure (3) of FIG. 9. Finally, SL transmission group 4 still includes SL transmissions I and G. The terminal device performs TX/RX prioritization for SL transmissions I and G, dropping SL transmission I and performing SL transmission G. Finally, the SL transmissions performed by the terminal device include SL transmissions A, B, and C for transmission, and SL transmission G for reception.

In some embodiments, the terminal device may prioritize performing SL transmission and/or SL reception based on an SL transmission group where an SL transmission with a lowest priority value is located.

In some embodiments, in the case where at least two SL transmission groups share an SL transmission with a lowest priority value, the priority order between the at least two SL transmission groups depends on the implementation of the terminal device.

Exemplarily, as illustrated in FIG. 9, SCSs of carriers 1-4 are 60, 30, 30, and 15 kHz, respectively. Therefore, a slot of carrier 4 corresponds to 2 slots of carriers 2 and 3, and 4 slots of carrier 1. In sub-figure (1) of FIG. 9, SL transmissions A-I can be divided into four SL transmission groups. SL transmissions A, C, D, and E form SL transmission group 1, SL transmissions B, C, D, and E form SL transmission group 2, SL transmissions H, G, F, and E form SL transmission group 3, and SL transmissions I, G, F, and E form SL transmission group 4. Assuming that the transmission capability of the terminal device allows the terminal device to support simultaneous transmission of at most two SL transmissions, a TX/TX conflict (the first type of conflict) exists in both SL transmission groups 1 and 2, requiring the terminal device to perform TX/TX prioritization. Due to the half-duplex constraints, both a TX/TX conflict (the first type of conflict) and a TX/RX conflict (the second type of conflict) exist in SL transmission groups 3 and both a TX/TX conflict (the first type of conflict) and a TX/RX conflict (the second type of conflict) exist in SL transmission 4, requiring the terminal device to perform both TX/TX and TX/RX prioritization. The order between TX/TX and TX/RX prioritization for a single SL transmission group depends on the implementation of the terminal device. In the exemplary embodiment, for example, TX/TX prioritization is performed first, followed by TX/RX prioritization, for illustrative purposes.

As illustrated in sub-figure (1) of FIG. 9, the lowest priority value corresponding to SL transmissions A-I is 0, that is, the SL transmission with the lowest priority value is SL transmission A, located in SL transmission group 1. Accordingly, the terminal device first performs TX/TX prioritization for SL transmission group 1, dropping SL transmissions D and E, as illustrated in sub-figure (2) of FIG. 9.

In sub-figure (2) of FIG. 9, for SL transmissions A, B, and C, SL transmissions A and C need to be simultaneously transmitted in SL transmission group 1, and SL transmissions B and C need to be simultaneously transmitted in in SL transmission group 2, both of which do not exceed the maximum transmission capability of the terminal device; thus, SL transmissions A, B, and C can be transmitted directly. For SL transmissions H, I, G, and F, SL transmission group 3 still includes SL transmissions H, G, and F, and SL transmission group 4 still includes I, G, and F. In this case, SL transmission groups 3 and 4 share the same SL transmissions G and F, and both include a TX/RX conflict (the second type of conflict). Therefore, SL transmission and/or reception still need to be performed based on an SL transmission group where an SL transmission with the lowest priority value is located. As illustrated in sub-figure (2) of FIG. 9, the lowest priority value corresponding to SL transmission H, I, G, and F is 2. In this case, SL transmission groups 3 and 4 share the same SL transmission G, and the priority order between SL transmission groups 3 and 4 can be determined depending on the implementation of the terminal device. For example, the terminal device first performs TX/RX prioritization for SL transmission group 3, dropping SL transmissions H and F and performing SL transmission G, as illustrated in sub-figure (3) of FIG. 9. Finally, SL transmission group 4 still includes SL transmissions I and G. The terminal device performs TX/RX prioritization for SL transmissions I and G, dropping SL transmission I and performing SL transmission G. Finally, the SL transmissions performed by the terminal device include SL transmissions A, B, and C for transmission, and SL transmission G for reception.

In the above method, the terminal device performs SL transmission and/or SL reception in ascending order of the lowest priority values corresponding to the SL transmission groups, or based on an SL transmission group where an SL transmission with the lowest priority value is located. The terminal device can determine a determination order between SL transmission groups. This avoids differences in final transmissions caused by different determination orders. In addition, an SL transmission or SL transmission group with a lowest priority value is prioritized to avoid dropping necessary SL transmissions as much as possible.

2. The terminal device performs SL transmission and/or SL reception based on priority values of the same SL transmission in multiple SL transmission groups.

In some embodiments, the terminal device determines, based on priority values of the same SL transmission, relative priority values of the same SL transmission in multiple SL transmission groups, and performs SL transmission and/or SL reception in descending order of the relative priority values.

In some embodiments, a relative priority value of an SL transmission in an SL transmission group is determined based on a relative rank or relative order of the SL transmission in the SL transmission group. For example, SL transmission group 1 includes SL transmissions A-E, where priority values of SL transmissions A-E are respectively 0, 1, 2, 4, and 5; and SL transmission group 2 includes SL transmissions E-I, where priority values of SL transmissions E-I are respectively 5, 2, 4, 1, and 6. In this case, SL transmission group 1 and SL transmission group 2 share the same SL transmission E. The priority rank or order of SL transmission E is fifth in SL transmission group 1 and fourth in SL transmission group 2. Accordingly, the terminal device may determine that the relative priority value of SL transmission E is 4 in SL transmission group 1 and 3 in SL transmission group 2. For example, the relative priority value may be equal to the relative rank or relative order minus 1. For example, the relative priority value may be equal to the relative rank or relative order. As an example for illustration, the relative priority value equals the relative rank or relative order minus 1 in the present embodiment.

In some embodiments, the minimum value of the relative priority value is 0, and the minimum value of the relative rank or relative order is 1.

In some embodiments, the relative rank or relative order of the same SL transmission in an SL transmission group may be converted into a relative priority value, or the terminal device may directly use the relative rank or relative order for performing prioritization.

In some embodiments, in the case where the same SL transmission has a same relative priority value in at least two SL transmission groups, the priority order between the at least two SL transmission groups depends on the implementation of the terminal device. For example, SL transmission group 1 includes SL transmissions A-E, where priority values of SL transmissions A-E are respectively 0, 1, 2, 4, and 5; and SL transmission group 2 includes SL transmissions E-I, where priority values of SL transmissions E-I are respectively 5, 2, 4, 1, and 3. In this case, SL transmission group 1 and SL transmission group 2 share the same SL transmission E, and a priority order of SL transmission E is fifth in both SL transmission group 1 and SL transmission group 2. Thus, the priority order between SL transmission group 1 and SL transmission group 2 depends on the implementation of the terminal device.

In some embodiments, in the case where the same SL transmission has a priority value same to that of another SL transmission in an SL transmission group, the relative priority value of the same SL transmission in that SL transmission group depends on the implementation of the terminal device. For example, SL transmission group 1 includes SL transmissions A-E, where priority values of SL transmissions A-E are respectively 0, 1, 2, 4, and 4; and SL transmission group 2 includes SL transmissions E-I, where priority values of SL transmissions E-I are respectively 4, 2, 4, 1, and 3. In this case, the relative priority values of SL transmission E in both SL transmission group 1 and SL transmission group 2 depend on the implementation of the terminal device. In one case, for SL transmission group 1, the terminal device determines that SL transmissions D and E have the same relative priority value, e.g., the same relative priority value of 4; and for SL transmission group 2, the terminal device determines that SL transmissions E and G have the same relative priority value, e.g., the same relative priority value of 3. In another case, for SL transmission group 1, the terminal device determines that SL transmissions D and E have different relative priority values, where the relative priority value of SL transmission D and the relative priority value of SL transmission E in SL transmission group 1 depend on the implementation of the terminal device, for example, the relative priority value of SL transmission D is 3, and the relative priority value of SL transmission E is 4. For SL transmission group 2, the terminal device may determine that SL transmissions E and G have different relative priority values, where the relative priority value of SL transmission E and the relative priority value of SL transmission G in SL transmission group 2 depend on the implementation of the terminal device, for example, the relative priority value of SL transmission D is 3, and the relative priority value of SL transmission E is 4.

In some embodiments, in the case where multiple SL transmission groups share at least two same SL transmissions, the terminal device performs SL transmission and/or SL reception based on a relative priority value of an SL transmission having the largest priority value in the at least two same SL transmissions. For example, SL transmission group 1 and SL transmission group 2 both include SL transmissions A and B, where the priority value of SL transmission A is 1, and the priority value of SL transmission B is 2. In this case, the terminal device performs SL transmission and/or SL reception based on the relative priority value of SL transmission B.

In some embodiments, in the case where multiple SL transmission groups share at least two same SL transmissions, the relative priority value of which of the at least two same SL transmissions is selected for SL transmission and/or SL reception depends on the implementation of the terminal device. For example, SL transmission group 1 and SL transmission group 2 both include SL transmissions A and B. Depending on the implementation of the terminal device, the terminal device may determine to perform SL transmission and/or SL reception based on the relative priority value of SL transmission A or based on the relative priority value of SL transmission B.

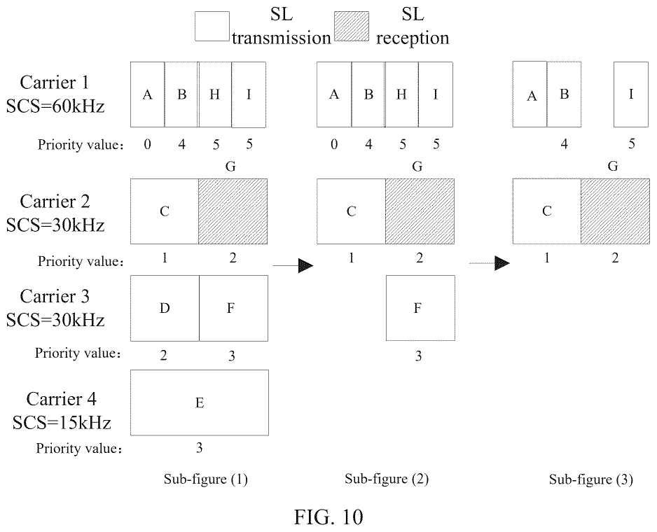

For example, as illustrated in FIG. 10, SCSs of carriers 1-4 are 60, 30, 30, and 15 kHz, respectively. Accordingly, a slot of carrier 4 corresponds to 2 slots of carrier 2 and 2 slots of carrier 3, and corresponds to 4 slots of carrier 1. In sub-figure (1) of FIG. 10, SL transmissions A-I may be divided into four SL transmission groups, where SL transmissions A, C, D, and E form SL transmission group 1, SL transmissions B, C, D, and E form SL transmission group 2, SL transmissions H, G, F, and E form SL transmission group 3, and SL transmissions I, G, F, and E form SL transmission group 4. Assuming that the transmission capability of the terminal device allows the terminal device to support simultaneous transmission of at most two SL transmissions, a TX/TX conflict (the first type of conflict) exists in SL transmission groups 1 and 2, requiring the terminal device to perform TX/TX prioritization. Due to the half-duplex constraints, both a TX/TX conflict (the first type of conflict) and a TX/RX conflict (the second type of conflict) exist in SL transmission group 3 and both a TX/TX conflict (the first type of conflict) and a TX/RX conflict (the second type of conflict) exist in transmission group 4, requiring the terminal device to perform both TX/TX and TX/RX prioritization. The order between TX/TX and TX/RX prioritization for a single SL transmission group depends on the implementation of the terminal device. In an example, TX/TX prioritization is performed first, followed by TX/RX prioritization, for illustrative purposes.

SL transmission groups 1-4 share the same SL transmission E. The terminal device calculates the respective relative priority values of SL transmission E in the SL transmission groups based on the priority values of SL transmission E, and performs SL transmission and/or SL reception in descending order of the relative priority values. As illustrated in sub-figure (1) of FIG. 10, the relative priority value of SL transmission E is 3 in SL transmission group 1, in other words, the relative rank or relative order of SL transmission E is 4 in SL transmission group 1; the relative priority value of SL transmission E is 2 in SL transmission group 2, in other words, the relative rank or relative order of SL transmission E is 3 in SL transmission group 2; the relative priority value of SL transmission E is 1 in SL transmission groups 3 and 4, in other words, the relative rank or relative order of SL transmission E is 2 in SL transmission groups 3 and 4. It may be noted that, the priority values of SL transmissions E and F are same in SL transmission groups 3 and 4, and therefore the priority orders of SL transmissions E and F depends on the implementation of the terminal device. If SL transmissions E and F have the same priority order, the relative priority values of SL transmissions E and F may both be 1 or both be 2. If SL transmissions E and F have different priority orders, the relative priority value of SL transmission E may be 1 and the relative priority value of SL transmission F may be 2, or the relative priority value of SL transmission E may be 2 and the relative priority value of SL transmission F may be 1. Since SL transmission E has the largest relative priority value in SL transmission group 1, the terminal device first performs TX/TX prioritization for SL transmission group 1. As a result, SL transmissions D and E are dropped, as illustrated in sub-figure (2) of FIG. 10.

In sub-figure (2) of FIG. 10, since the number of SL transmissions that need to be simultaneously transmitted does not exceed the maximum transmission capability of the terminal device, SL transmissions A, B, and C may be transmitted directly. SL transmissions H, I, G, and F may still be divided into two SL transmission groups, where SL transmissions H, G, and F form SL transmission group 3, and SL transmissions I, G, and F form SL transmission group 4. SL transmission groups 3 and 4 still share same SL transmissions G and F, and both SL transmission groups 3 and 4 include a TX/RX conflict (a second type of conflict). Therefore, the terminal device still needs to calculate the relative priority values of SL transmission G or F in SL transmission groups 3 and 4 and perform SL transmission and/or SL reception in descending order of the relative priority values. In the case where SL transmission groups 3 and 4 share multiple same SL transmissions, the relative priority value may optionally be determined based on the SL transmission having the largest priority value. Alternatively, which same SL transmission is selected to calculate the relative priority value depends on the implementation of the terminal device. In sub-figure (2) of FIG. 10, since the priority value of SL transmission F is larger than that of SL transmission G, the relative priority values of SL transmission F in SL transmission groups 3 and 4 are calculated. Since the relative priority values of SL transmission F in SL transmission groups 3 and 4 are both 1, the terminal device first performs TX/RX prioritization for SL transmission group 3 depending on the implementation of the terminal device, then the terminal device drops SL transmissions H and F, and performs SL transmission G, which is as illustrated in sub-figure (3) of FIG. 10. Finally, the terminal device performs TX/RX prioritization between SL transmissions I and G, dropping SL transmission I and performing SL transmission G.

Ultimately, the terminal device performs SL transmissions A, B, and C for transmission, and SL transmission G for reception.

Based on the above method, the terminal device performs SL transmission and/or SL reception based on the relative priority values of the same SL transmission in multiple SL transmission groups, and thus the terminal device may decouple SL transmission groups, avoiding dropping necessary SL transmissions.

3. The terminal device performs SL transmission and/or SL reception based on time-domain positions of transmissions in the multiple SL transmission groups

In some embodiments, the terminal device performs SL transmission and/or SL reception according to time-domain positions of transmissions in each SL transmission group, following a sequential order from earlier to later.

In some embodiments, the terminal device performs SL transmission and/or SL reception based on the latest start position of transmissions in each SL transmission group, following a sequential order from earlier to later.

In some embodiments, the terminal device performs SL transmission and/or SL reception based on the earliest end position of transmissions in each SL transmission group, following a sequential order from earlier to later.

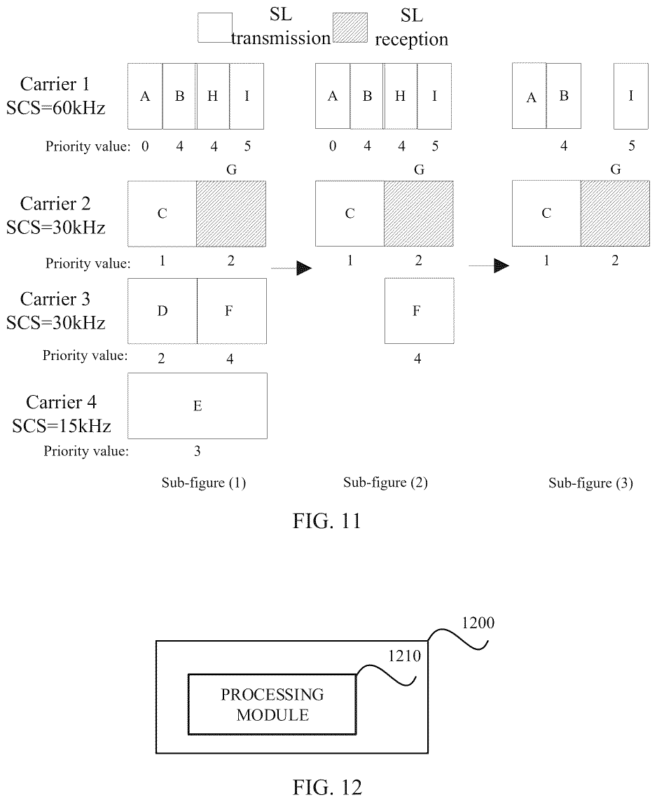

Exemplarily, as illustrated in FIG. 11, SCSs of carriers 1-4 are 60, 30, 30, and 15 kHz, respectively. Accordingly, a slot of carrier 4 corresponds to 2 slots of carriers 2 and 3, and 4r slots of carrier 1. In sub-figure (1) of FIG. 11, SL transmissions A-I can be divided into four SL transmission groups, where SL transmissions A, C, D, and E form SL transmission group 1, SL transmissions B, C, D, and E form SL transmission group 2, SL transmissions H, G, F, and E form SL transmission group 3, and SL transmissions I, G, F, and E form SL transmission group 4. Supposing the transmission capability of the terminal device supports simultaneous transmission of at most 2 SL transmissions, a TX/TX conflict (the first type of conflict) exists in both SL transmission groups 1 and 2, and thus the terminal device needs to perform TX/TX prioritization. Due to the half-duplex constraints, both a TX/TX conflict (the first type of conflict) and a TX/RX conflict (the second type of conflict) exist in SL transmission group 3 and both a TX/TX conflict (the first type of conflict) and a TX/RX conflict (the second type of conflict) exist in SL transmission group 4, that is, the terminal device needs to perform both TX/TX and TX/RX prioritization. The order between TX/TX and TX/RX prioritization for a single SL transmission group depends on the implementation of the terminal device. In an example, the terminal device first performs TX/TX prioritization, followed by TX/RX prioritization, for illustrative purposes.

The terminal device performs SL transmission and/or SL reception based on the time-domain positions of transmissions in each SL transmission group, following a sequential order from earlier to later. Exemplarily, SL transmission and/or SL reception is performed in a sequential order from earlier to later based on the earliest end position or the latest start position of transmissions in each SL transmission group. For instance, as illustrated in sub-figure (1) of FIG. 11, among SL transmission groups 1-4, the latest start position of transmissions in SL transmission group 1 is earlier than the latest start position of transmissions in SL transmission groups 2-4. Therefore, the terminal device first performs TX/TX prioritization for SL transmission group 1, resulting in SL transmissions D and E being dropped, as illustrated in sub-figure (2) of FIG. 11.

In sub-figure (2) of FIG. 11, for SL transmissions A, B, and C, since the number of SL transmissions that need to be simultaneously transmitted does not exceed the maximum transmission capability of the terminal device, SL transmissions A, B, and C can be transmitted directly. SL transmissions H, I, G, and F can still be divided into two SL transmission groups, where SL transmissions H, G, F form SL transmission group 3, and SL transmissions I, G, F form SL transmission group 4. SL transmission groups 3 and 4 share same SL transmissions G and F, and include a TX/RX conflict (the second type of conflict). Therefore, it still needs to perform SL transmission and/or SL reception based on the time-domain positions of transmissions in each SL transmission group, following a sequential order from earlier to later. As illustrated in sub-figure (2) of FIG. 11, the latest start position of transmissions in SL transmission group 3 is earlier than that in SL transmission group 4. Thus, the terminal device performs TX/RX prioritization for SL transmission group 3, dropping SL transmissions H and F and performing SL transmission G, as illustrated in sub-figure (3) of FIG. 11. Finally, the terminal device performs TX/RX prioritization between transmissions I and G, dropping SL transmission I and performing SL transmission G.

Finally, the terminal device performs SL transmissions A, B, and C for transmission, and SL transmission G for reception.

Based on the above method, the terminal device performs SL transmission and/or SL reception according to the time-domain positions of transmissions in multiple SL transmission groups, thereby unifying the determination order across all SL transmission groups and avoiding differences in final SL transmissions caused by different determination orders.

The following are apparatus embodiments of the present disclosure, which may be used to implement the method embodiments of the present disclosure. For details not disclosed in the apparatus embodiments of the present disclosure, reference may be made to the method embodiments of the present disclosure.

Reference is made to FIG. 12, which is a block diagram of an apparatus for SL transmission according to an embodiment of the present disclosure. The apparatus has functions for implementing the above-described examples of the method for SL transmission, and the functions may be implemented by hardware or by hardware executing corresponding software. The apparatus may be the terminal device described above, or may be disposed within the terminal device. As illustrated in FIG. 12, the apparatus 1200 may include a processing module 1210.

The processing module 1210 is configured to perform SL transmission and/or SL reception based on priority values of multiple SL transmissions, where at least two SL transmissions among the multiple SL transmissions correspond to different SCSs.

In some embodiments, the multiple SL transmissions are divided into multiple SL transmission groups, where each of the multiple SL transmission groups includes at least two SL transmissions among the multiple SL transmissions, and respective SL transmissions in each of the multiple SL transmission groups overlap in a time domain.

In some embodiments, the multiple SL transmission groups share at least one same SL transmission.

In some embodiments, the processing module 1210 is configured to perform SL transmission and/or SL reception based on lowest priority values corresponding to the multiple SL transmission groups.

In some embodiments, the processing module 1210 is configured to perform SL transmission and/or SL reception in ascending order of the lowest priority values corresponding to the multiple SL transmission groups.

In some embodiments, the processing module 1210 is configured to preferentially perform SL transmission and/or SL reception based on an SL transmission group in which an SL transmission having a lowest priority value is located.

In some embodiments, the processing module 1210 is configured to perform SL transmission and/or SL reception based on priority values of a same SL transmission in the multiple SL transmission groups.

In some embodiments, the processing module 1210 is configured to determine, based on the priority values of the same SL transmission, relative priority values of the same SL transmission in the multiple SL transmission groups, and perform SL transmission and/or SL reception in descending order of the relative priority values.

In some embodiments, the processing module 1210 is configured to perform SL transmission and/or SL reception based on time-domain positions of transmissions in the multiple SL transmission groups.

In some embodiments, the processing module 1210 is configured to perform SL transmission and/or SL reception based on the time-domain positions of transmissions in the multiple SL transmission groups, following a sequential order from earlier to later.

In some embodiments, each of the multiple SL transmission groups includes a first type of conflict and/or a second type of conflict, where the first type of conflict refers to a conflict between SL transmissions for transmission, and the second type of conflict refers to a conflict between an SL transmission for transmission and an SL transmission for reception.

In some embodiments, in a case where one of the multiple SL transmission groups includes both the first type of conflict and the second type of conflict, an order of resolving the first type of conflict and the second type of conflict depends on an implementation of the terminal device.

In some embodiments, the multiple SL transmissions are located on at least two carriers.

In some embodiments, each of the multiple SL transmissions is used to transmit any one of the following channels or signals: a PSCCH, a PSSCH, a PSCCH and a PSSCH, a PSFCH, and an S-SSB.

In some embodiments, for each of the multiple SL transmissions, an SCS corresponding to the SL transmission refers to: an SCS of a carrier where the SL transmission is located; or an SCS of an SL BWP where the SL transmission is located; or an SCS of an SL BWP of a carrier where the SL transmission is located.

In some embodiments, for each of the multiple SL transmissions: (I) the SL transmission is used to transmit any one of a PSCCH, a PSSCH, and a PSCCH and a PSSCH; and a priority value of the SL transmission refers to a priority value of data carried in the PSSCH, or a priority value indicated by SL control information in the PSCCH; or (II) the SL transmission is used to transmit a PSFCH; and the priority value of the SL transmission refers to a priority value of a PSSCH corresponding to the PSFCH; or (III) the SL transmission is used to transmit an S-SSB; and the priority value of the SL transmission is configured, preconfigured, or predefined in a standard.

In the technical solution provided in the embodiments of the present disclosure, in the case where some SL transmissions among multiple SL transmissions correspond to different SCSs, the terminal device performs SL transmission and/or SL reception based on priority values of the multiple SL transmissions. This solves the problem of a TX/TX conflict and/or a TX/RX conflict among SL transmissions in the case where some SL transmissions among multiple SL transmissions correspond to different SCSs, improving the reliability of SL transmissions, particularly, improving the reliability of SL transmissions having a high priority.

It may be noted that, the division of the respective functional modules is taken an example for illustrating the apparatus provided in the above embodiments implementing its functions. In practical applications, the above functions may be allocated to different functional modules as needed. In other words, the structural content of the apparatus may be divided into different functional modules to implement all or part of the functions described above.

With respect to the apparatus in the above embodiments, the specific manners in which the respective modules perform operations have already been described in detail in the method embodiments related thereto, and thus will not be elaborated again herein. For details not explicitly described in the apparatus embodiments, reference may be made to the method embodiments of the present disclosure.

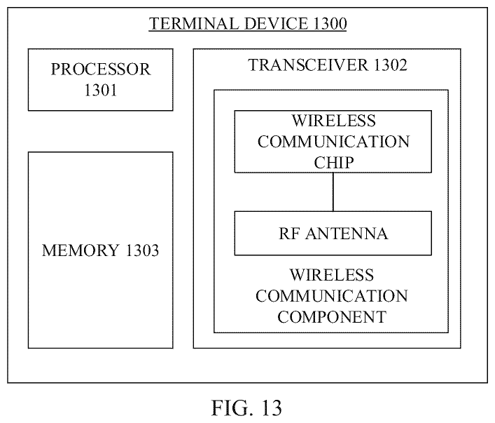

Reference is made to FIG. 13, which is a schematic structural diagram of a terminal device according to an embodiment of the present disclosure. The terminal device 1300 may include a processor 1301, a transceiver 1302, and a memory 1303. The transceiver 1302 is configured to perform transmission and/or reception. The processor 1301 is configured to perform other processing functions or to control transmission and/or reception, for example, to implement the functions of the processing module 1210 described above.

The processor 1301 may include one or more processing cores and may execute various functional applications and information-processing tasks by running software programs and modules.

The transceiver 1302 may include a receiver and a transmitter. For example, the receiver and the transmitter may be implemented as a single wireless communication component, which may include a wireless communication chip and a radio-frequency antenna.

The memory 1303 may be coupled to the processor 1301 and the transceiver 1302.

The memory 1303 may be configured to store computer programs executable by the processor, and the processor 1301 is configured to execute such computer programs so as to implement the steps of the method embodiments described above.

In some embodiments, the processor 1301 is configured to perform SL transmission and/or SL reception based on priority values of multiple SL transmissions, where at least two SL transmissions among the multiple SL transmissions correspond to different SCSs.

With respect to details not explicitly described in the present embodiment, reference may be made to the embodiments described above and will not be repeated here.

In addition, the memory may be implemented using any type of volatile or non-volatile storage device, or any combination thereof. Examples of volatile or non-volatile storage devices may include, but are not limited to: magnetic or optical disk, electrically erasable programmable read-only memory (EEPROM), erasable programmable read-only memory (EPROM), static random-access memory (SRAM), read-only memory (ROM), magnetic memory, flash memory, and programmable read-only memory (PROM).

The present disclosure further provides a computer-readable storage medium, on which a computer program is stored. The computer program, when executed by a processor, is configured to implement the method for SL transmission as described above. In some embodiments, the computer-readable storage medium may include a ROM, a RAM, a solid state drive (SSD), an optical disk, and the like. The RAM may include a resistance random access memory (ReRAM) and a dynamic random access memory (DRAM).

The present disclosure further provides a chip, which includes a programmable logic circuit and/or program instructions. When the chip operates, the chip is configured to implement the method for SL transmission as described above.

The present disclosure further provides a computer program product, which includes computer instructions stored on a computer-readable storage medium. A processor is configured to read and execute the computer instructions from the computer-readable storage medium to implement the method for SL transmission as described above.

It may be understood that, the term “indicate” referred in the embodiments of the present disclosure may refer to a direct indication, an indirect indication, or indicate an association. For example, “A indicates B” may mean that A directly indicates B, such as B can be obtained from A; or that A indirectly indicates B, such as A indicates C, and B can be obtained from C; or that A and B are associated.

In the embodiments of the present disclosure, the term “correspond to” may indicate a direct or indirect correspondence between two items, an association relationship, or a relationship such as indicating/being indicated or configuring/being configured.

In some embodiments of the present disclosure, the “pre-defined” can be implemented by pre-saving a corresponding code or table in a device (for example, including the terminal device and the network device) or in other manners that can be used for indicating related information, and the present disclosure is not limited in this regard. For example, the “pre-defined” may mean defined in a protocol.

In some embodiments of the present disclosure, the “protocol” may refer to a communication standard protocol, which may include, for example, an LTE protocol, an NR protocol, and a protocol applied to a future communication system, and the present disclosure is not limited in this regard.

“A plurality of” or “multiple” referred in the present disclosure refers to two or more. “And/or” describes an association relationship between associated objects, which means that there may be three relationships. For example, A and/or B can mean A alone, both A and B exist, and B alone. The character “/” herein generally indicates that the associated objects are in an “or” relationship.

As used herein, “greater than or equal to” may refer to “greater than or equal to” or “greater than,” and “less than or equal to” may refer to “less than or equal to” or “less than.”

In addition, the step numbers used herein merely illustrate one possible order of execution. In other embodiments, the steps may be not executed in an order of the numbers, such as two steps with different numbers being performed concurrently or in reverse order. The embodiments of the present disclosure are not limited thereto.

One skilled in the art will appreciate that, in one or more of the above examples, the functionalities described in the embodiments of the present disclosure may be implemented using hardware, software, firmware, or any combination thereof. When implemented using software, such functionalities may be stored on a computer-readable medium or transmitted as one or more instructions or codes on a computer-readable medium. A computer-readable medium may include both computer storage media and communication media, and communication media include any medium that facilitates transfer of a computer program from one place to another. Storage media may be any available media accessible by general-purpose or special-purpose computers.

The foregoing embodiments are merely exemplary embodiments of the present disclosure and are not intended to limit the present disclosure. Any modifications, equivalent substitutions, or improvements made within the spirit and principles of the present disclosure are intended to be included within the scope of the present disclosure.

What is claimed is:

1. A method for sidelink (SL) transmission, the method being executed by a terminal device and comprising:
performing at least one of SL transmission and SL reception based on priority values of a plurality of SL transmissions, wherein at least two SL transmissions among the plurality of SL transmissions correspond to different subcarrier spacings (SCSs).

2. The method of claim 1, wherein the plurality of SL transmissions are divided into a plurality of SL transmission groups, wherein each of the plurality of SL transmission groups comprises at least two SL transmissions among the plurality of SL transmissions, and respective SL transmissions in each of the plurality of SL transmission groups overlap in a time domain.

3. The method of claim 2, wherein the plurality of SL transmission groups share at least one same SL transmission.

4. The method of claim 2, wherein performing at least one of SL transmission and SL reception based on the priority values of the plurality of SL transmissions comprises:
performing at least one of SL transmission and SL reception based on lowest priority values corresponding to the plurality of SL transmission groups.

5. The method of claim 4, wherein performing at least one of SL transmission and SL reception based on the lowest priority values corresponding to the plurality of SL transmission groups comprises:
performing at least one of SL transmission and SL reception in ascending order of the lowest priority values corresponding to the plurality of the SL transmission groups.

6. The method of claim 2, wherein performing at least one of SL transmission and SL reception based on the priority values of the plurality of SL transmissions comprises:
preferentially performing at least one of SL transmission and SL reception based on an SL transmission group in which an SL transmission having a lowest priority value is located.

7. The method of claim 2, wherein performing at least one of SL transmission and SL reception based on the priority values of the plurality of SL transmissions comprises:
performing at least one of SL transmission and SL reception based on priority values of a same SL transmission in the plurality of SL transmission groups.

8. The method of claim 7, wherein performing at least one of SL transmission and SL reception based on the priority values of the same SL transmission in the plurality of SL transmission groups comprises:
determining, based on the priority values of the same SL transmission, relative priority values of the same SL transmission in the plurality of SL transmission groups, and performing at least one of SL transmission and SL reception in descending order of the relative priority values.

9. The method of claim 2, wherein performing at least one of SL transmission and SL reception based on the priority values of the plurality of SL transmissions comprises:
performing at least one of SL transmission and SL reception based on time-domain positions of transmissions in the plurality of SL transmission groups.

10. The method of claim 9, wherein performing at least one of SL transmission and SL reception based on the time-domain positions of transmissions in the plurality of SL transmission groups comprises:
performing at least one of SL transmission and SL reception based on the time-domain positions of transmissions in the plurality of SL transmission groups, following a sequential order from earlier to later.

11. The method of claim 2, wherein each of the plurality of SL transmission groups comprises at least one of a first type of conflict and a second type of conflict, wherein the first type of conflict refers to a conflict between SL transmissions for transmission, and the second type of conflict refers to a conflict between an SL transmission for transmission and an SL transmission for reception.

12. The method of claim 11, wherein in a case where one of the plurality of SL transmission groups comprises both the first type of conflict and the second type of conflict, an order of resolving the first type of conflict and the second type of conflict depends on an implementation of the terminal device.

13. The method of claim 1, wherein the plurality of SL transmissions are located on at least two carriers.

14. The method of claim 1, wherein each of the plurality of SL transmissions is used to transmit any one of the following channels or signals: a physical sidelink control channel (PSCCH), a physical sidelink shared channel (PSSCH), a PSCCH and a PSSCH, a physical sidelink feedback channel (PSFCH), and a sidelink-synchronization signal (SS)/physical broadcast channel (PBCH) block (S-SSB).

15. The method of claim 1, wherein for each of the plurality of SL transmissions, an SCS corresponding to the SL transmission refers to:
an SCS of a carrier where the SL transmission is located; or
an SCS of an SL bandwidth part (BWP) where the SL transmission is located; or
an SCS of an SL BWP of a carrier where the SL transmission is located.

16. The method of claim 1, wherein for each of the plurality of SL transmission:
the SL transmission is used to transmit any one of a PSCCH, a PSSCH, and a PSCCH and a PSSCH; and a priority value of the SL transmission refers to a priority value of data carried in the PSSCH, or a priority value indicated by SL control information in the PSCCH; or
the SL transmission is used to transmit a PSFCH; and the priority value of the SL transmission refers to a priority value of a PSSCH corresponding to the PSFCH; or
the SL transmission is used to transmit an S-SSB; and the priority value of the SL transmission is configured, preconfigured, or predefined in a standard.

17. A terminal device, comprising:
a processor; and
a memory storing a computer program which, when executed by the processor, causes the terminal device to:
perform at least one of sidelink (SL) transmission and SL reception based on priority values of a plurality of SL transmissions, wherein at least two SL transmissions among the plurality of SL transmissions correspond to different subcarrier spacings (SCSs).

18. The terminal device of claim 17, wherein the plurality of SL transmissions are divided into a plurality of SL transmission groups, wherein each of the plurality of SL transmission groups comprises at least two SL transmissions among the plurality of SL transmissions, and respective SL transmissions in each of the plurality of SL transmission groups overlap in a time domain.

19. The terminal device of claim 18, wherein the computer program executed by the processor to cause the terminal device to perform at least one of SL transmission and SL reception based on the priority values of the plurality of SL transmissions is executed by the processor to cause the terminal device to perform at least one of SL transmission and SL reception based on lowest priority values corresponding to the plurality of SL transmission groups.

20. A non-transitory computer-readable storage medium storing a computer program, wherein the computer program is executable by a processor to:
perform at least one of sidelink (SL) transmission and SL reception based on priority values of a plurality of SL transmissions, wherein at least two SL transmissions among the plurality of SL transmissions correspond to different subcarrier spacings (SCSs).
